(19) United States
(12) Patent Application Publication
(10) Pub. No.: US 2003/0037215 A1
(43) Pub. Date: Feb. 20, 2003

(54) Embedded memory structure and the access method thereof

(76) Inventor: Ying-Chou Chen, Taipei (TW)

Correspondence Address: Keith Kline, PRO-TECHTOR INTERNATIONAL SERVICES, 20775 Norada Court, Saratoga, CA, 95070-3018, US

(21) Appl. No.: 10/218,502

(22) Filed: Aug. 13, 2002

(30) Foreign Application Priority Data
Aug. 15, 2001 (TW) 090119969

(51) Int. Cl. G06F 12/00

(52) U.S. Cl. 711/173; 711/171

(57) ABSTRACT

The invention discloses an embedded memory structure, using instantly and partially update components into the embedded memory. The embedded memory is previously divided into a first part, a second part and a third part. The third part is divided into a plurality of sections. The first part records the first basic property of the third part and the second part records the second basic property of the sections.

### BACKGROUND OF THE INVENTION

1. Field of the Invention

This invention discloses an embedded memory structure with the corresponding access method in an embedded structure for component, especially for instantly and partially updating component to the embedded memory.

2. Description of the Related Art

Now embedded system has been popularly applied to the network architecture of clients and servers, and further putting the embedded system into clients such as a set-top box, pocket pc and Internet DVD etc. Furthermore, such embedded system doesn't comprise any storage device such as a hard disk, and does only through main memory like RAM, usually 32 Mbytes to 64 Mbytes, in combination with an embedded memory like flash memory to previously store at least a compressed program and the related data. For example, within the Operation system of Linux or Win CE, after an embedded system is powered on, the data stored in the embedded memory is de-compressed and further stored into a main memory, then to be used in the main memory during executing. After that, the embedded system communicates with the servers only through the main memory so as to obtain the corresponding services and the instant information provided from the servers anytime. Referring to FIG. 1, it describes an example of the embedded system's basic structure. It includes a server device 100 and a customer device 101. Server device 100 can receive the demand of the customer device 101 and provide the information of the customer device 101 anytime. The customer device 101 includes a process unit 103, an embedded memory 102 and a main memory 104. In the customer device 101, the data and program in the embedded memory 102 need to be compressed in advance at one time and further to be entirely stored into such embedded memory 102. Once a rebooting of an Operation System (OS), the data and program of the embedded memory 102 will be de-compressed, and then further writed into the main memory 104 for executing.

In the foregoing system, the defects of the embedded memory are as follows:

(1) The embedded memory of the prior art can't be partially updated for only one part of components.

(2) The embedded memory of the prior art takes more time to de-compress all of the data and the routine of the embedded memory 102 while power on.

(3) After being de-compressed for the data and the routine of the embedded memory 102 as a de-compressed data and routine, the de-compressed data and routine all should be writed into the main memory 104. It also makes the unnecessary de-compressed data and routine occupy the main memory 104.

Due to the space of the memory 104 which is occupied by running program is getting bigger and bigger, it leads to the appearance of the related researches; among these researches, the expanding memory 104 space by partial compressing in combination with de-compressing is the most popular. This technology needs to previously write the necessary routine and the corresponding data thereof into the embedded memory 102. However, while the customer device 101 is powered on, we only need to write the necessary routine and the necessary data into a space location of the memory 104. When we want to execute such routine and the corresponding data, we only de-compress them in this location and store the decompressed routine and the data in the other space of the main memory 104. By this way, we can avoid spending more time due to compressing the entire program and the corresponding data thereof in the embedded memory 102. Besides, we can also avoid the space of the main memory 104 occupied by the unnecessary routine and the corresponding data thereof.

As shown in FIG. 2, the necessary routine and the corresponding data thereof 200 are previously compressed 201, then storing all of them into the embedded 102. After the customer device is powered on, we previously write the partial compressed routine and the corresponding data thereof into one space location 204 of the main memory 104. Then we de-compress the partial compress routine and the corresponding data thereof of the main memory 104 into the other space location 203 of the main memory 104 and executing it. In this figure, the embedded memory 102 occupies quite small space in the main memory 104 due to only writing partial routine and the corresponding data thereof into the main memory 104.

In such system, for updating the embedded memory, it is still previous and image update; it can't be partial and compon Vt be part.

According to the foregoing description, in the client-server structure, this invention discloses an embedded memory structure and the corresponding access method that are different from the prior techniques to partially update component into the embedded memory; it can definitely overcome the defects that prior techniques couldn't solve.

### SUMMARY OF THE INVENTION

The first objective of the invention discloses an embedded memory structure and the corresponding access method thereof to partially update component into the embedded memory so as to rid of the previous image update of the embedded in the prior techniques in the client-server structure.

The second objective of the invention discloses an embedded memory structure and the corresponding access method thereof to partially update component into the embedded memory so as to rid of wasting the space of the main memory occupied by unnecessary data due to de-compressing all the data of the embedded memory, then storing it in the main memory in the client-server structure.

The third objective of the invention discloses an embedded memory structure and the corresponding access method thereof to partially update component into the embedded memory so as to rid of wasting the time for compressing due to compressing all the data of the embedded memory through the techniques of the prior art in the client-server structure.

The fourth objective of the invention discloses an embedded memory structure and the corresponding access method thereof to partially update component into embedded memory so as to rid of wasting the time for uncompressing due to uncompressing all the data of the embedded memory through the techniques of the prior art in the client-server structure.

The fifth objective of the invention discloses an embedded memory structure and the corresponding access method thereof to partially update component into the embedded memory so as to rid of updating the embedded memory in advance through techniques of the prior art in the client-server structure.

According to the foregoing objectives, this invention, in the client-server structure, discloses an embedded memory structure and the corresponding access method thereof to instantly and partially update components into the embedded memory to reach the above-mentioned objectives as follows.

Such embedded memory structure and the corresponding access method thereof of the invention is in a client-server architecture. In the server device, a component-updated data is compressed to a new data section, and then send out a compressed section. In the customer device, it comprises a main memory and an embedded memory and receives the compressed section to the previously divided data section of the main memory through a routine to update a part of the section of the embedded memory. The embedded memory structure comprises a memory that is applied to a storage space of the embedded memory, and the characteristics are as follows: this memory is previously divided to a first part, a second part, and a third part thereof. The first part is a head of the memory, the second part is another head of the memory and the third part is a data section. Besides, the third part is divided into a plurality of sections, the first part records the first basic property of the third part, and the second part records the second basic property of the second part. The first property records the number of the size of the sections; the second property records the size, the location in third part and the compressing degree of the sections.

Furthermore, depending on the second property, we can get the compressing degree and the location of the sections to read the necessary section and de-compress the necessary section. Besides, it provides an enough writing space to store a compressed writing section and then change the second basic property to finish the writing action.

### BRIEF DESCRIPTION OF DRAWINGS

The following detailed description, given by way of examples and not intended to limit the invention to the embodiment described herein, will best be understood in conjunction with the accompanying drawings, in which:

FIG. 1 illustrates an example about the basic structure of the embedded system in the prior art;

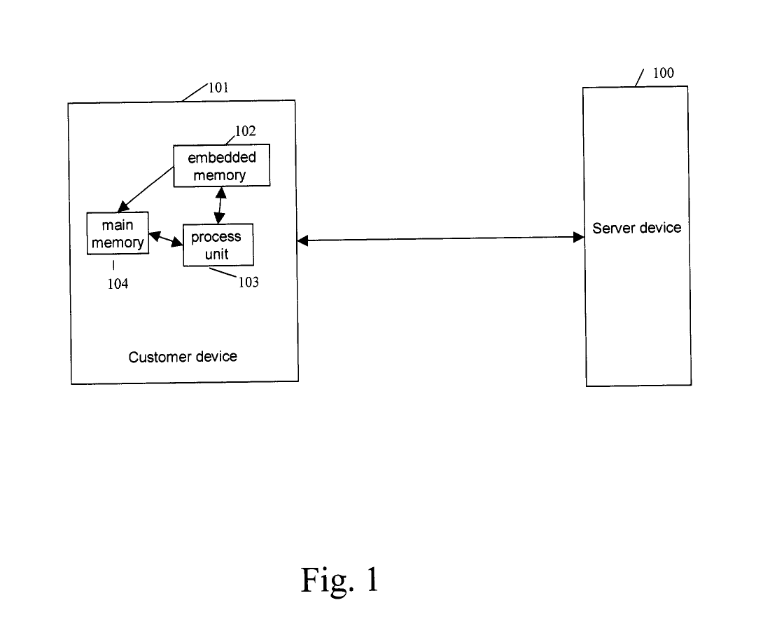

FIG. 2 illustrates the previous storing action of the embedded memory in the prior art;

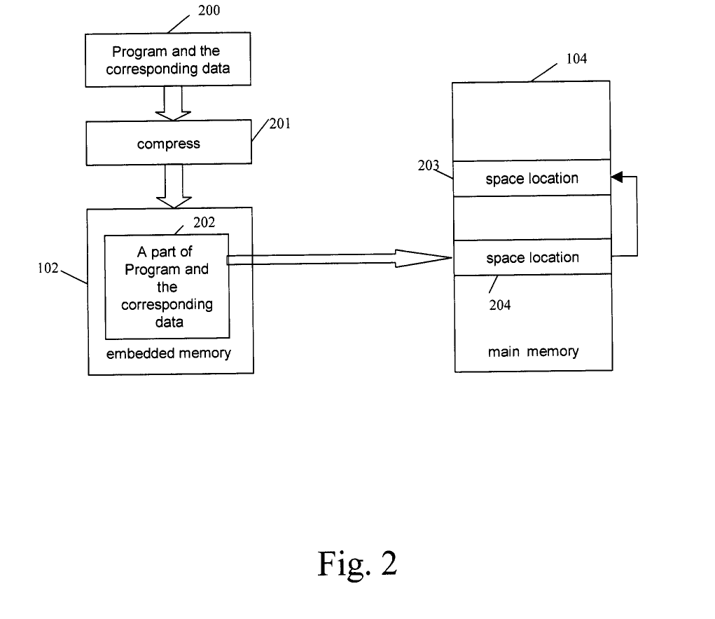

FIG. 3 illustrates that the invention discloses a partially updated embedded memory system in the client-server architecture;

FIG. 4 illustrates that the invention discloses a component updated embedded memory method in the client-server architecture;

FIG. 5 illustrates the embedded memory structure of the invention;

FIG. 6 further illustrates the embedded memory structure;

FIG. 7 illustrates the access method of this embedded memory structure; and

FIG. 8 illustrates the writing method of this embedded memory structure.

### DETAILED DESCRIPTION OF THE INVENTION

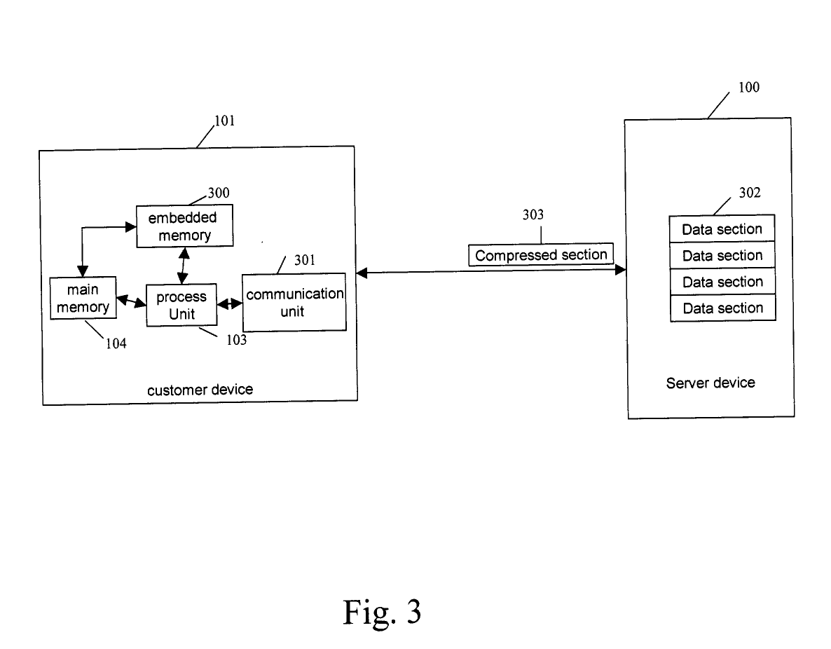

FIG. 3 illustrates that a component updated embedded memory system in the client-server architecture for the invention. Such system comprises a server device 100 and a customer device 101. The server device 100 divides a data into a plurality of data sections 302, wherein at least a data section 302 stores an updated data as an updated data section. And such server device 100 further compresses the updated data section, then sending out a compressed updated data (compressed section) 303. The customer device 101 comprises a process unit 103, communication unit 301, a main memory unit 104 and an embedded memory 300. After the customer device 101 connects the server device 100, it receives the compressed section 303 from the server device 100 and writes it to a specific section in the main memory 104 at the customer device 101. And then update one of sections of the embedded memory 300 through a routine for the specification section in the main memory 104. Such routine is often loaded from the embedded memory 300 in advance before the foregoing action.

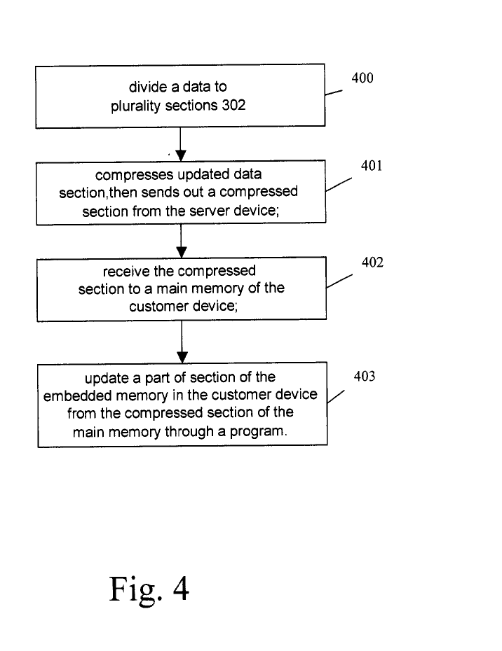

FIG. 4 illustrates a component updated embedded memory method in the client-server architecture for the invention. Within this figure, the follow chart of the method comprises steps as follows:

Step 400: divide a data into a plurality of data sections 302.

Step 401: write an updated data of the components into at least one of the data section 302 as an update data section 302 and compresses the updated data section 302 as a compressed updated data section 303, then sending out such compressed updated data section (compressed section) 303 from the server device.

Step 402: receive the compressed section 303 to a main memory 104 at the customer device 101.

Step 403: partially update at least one of the sections of the embedded memory 300 at the customer device 101 from the compressed section 303 of the main memory 104 through a routine.

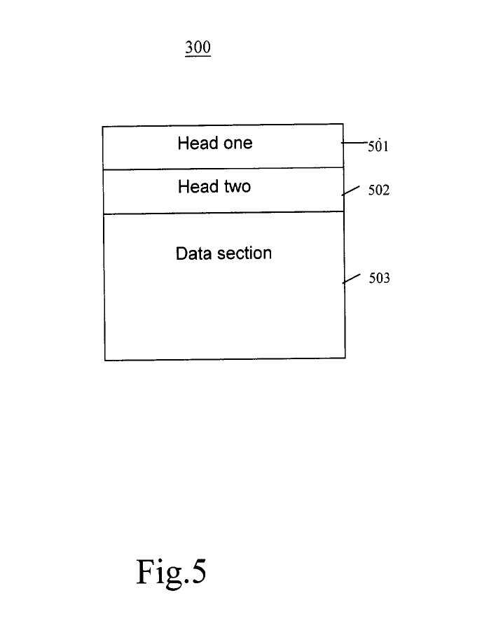

In the forgoing partially updated embedded memory system and method, the embedded memory structure is as shown in the FIG. 5. It illustrates the embedded memory structure of the invention as follows. Such embedded memory 300 is previously divided into three parts, first head (head one) 501, second head (head two) 502 and the data section 503. The head two 502 records the size, the location and the compressing degree of each data section 503. Furthermore, through the head two 502, we can get the compressing degree and the location of each data section 503 to read the necessary section and de-compress the section. And through re-allocate the data section 503, it can provide an enough writing space to write a compressed section and then change the head two 502 to finish such writing action.

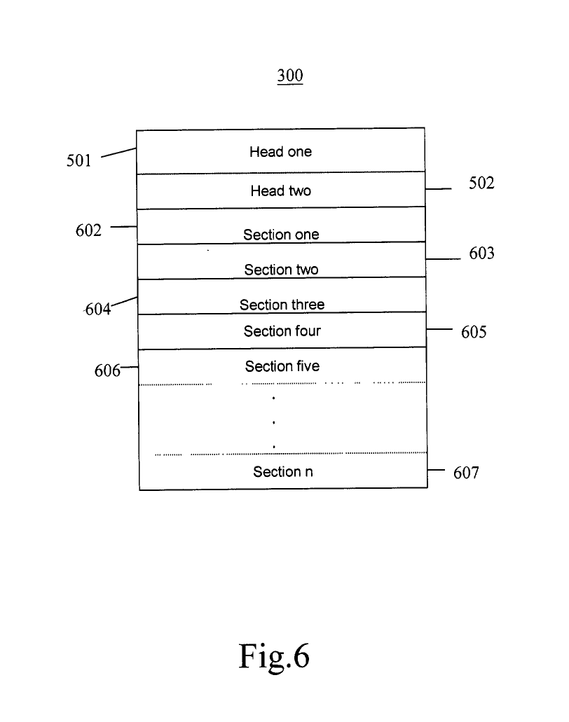

Referring to the FIG. 6, it illustrates the detail embedded memory structure, in this figure, the embedded memory structure is the same as the foregoing description, which comprises the head one 501, the head two 502. Besides, the data section 503 is divided into a section one 602, section two 603, section three 604, section four 605, section five 606 and section n 607. The head 502 can get the property of the section 602 to 607.

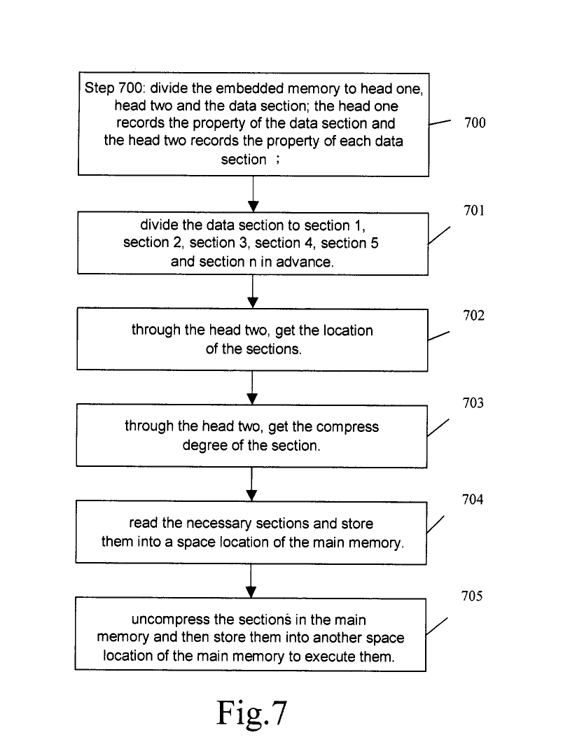

Through the foregoing embedded memory structure, the invention discloses the access method of the embedded memory structure, as shown in the FIG. 7 as follows.

Step 700: divide an embedded memory 300 to the head one 501, head two 502 and the data section 503; the head one 501 records the property of the data section 503 and the head two 502 records the property of each data section 503.

Step 701: divide the data section 503 to the section one 602, section two 603, section three 604, section four 605, section five 606 and section n 607 in advance.

Step 702: through the head two 502, we can get the location of the section 602 to 607.

Step 703: through the head two 502, we can get the compressed degree of the section 602 to 607.

Step 704: read the necessary sections from section 602 to 607 and write them into a space location 204 in the main memory 104; and

Step 705: compress the section 602 to 607 in the main memory and then write them into another space location 203 in the main memory 104 to execute them.

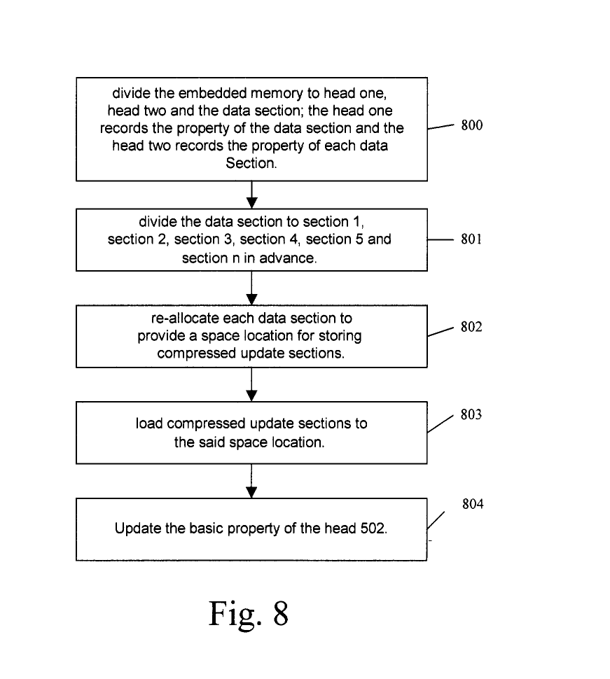

Furthermore, through the foregoing embedded memory structure, the invention further discloses the writing method of the embedded structure, as shown in FIG. 8 as follows.

Step 800: divide an embedded memory 300 to the head one 501, head two 502 and the data section 503; the head one 501 records the property of the data section 503 and the head two 502 records the property of each data section 503.

Step 801: divide the data section 503 into the section one 602, section two 603, section three 604, section four 605, section five 606 and section n 607 in advance.

Step 802: re-allocate each data section 503 to provide a space location for writing compressed updated sections.

Step 803: writing the compressed updated sections to the space location; and

Step 804: update the basic property of the head 502.

Although described above in connection with the preferred embodiments, one skilled in the art will appreciate that the present invention can be implemented in other embodiments while remaining within the scope of the present invention as defined in the appended claims.

What is claimed is:

1. An embedded memory structure, comprising:
a memory that applies to a storage space of said embedded system and that previously divided into a first part, a second part and a third part, said third part being divided into a plurality of sections, said first part recording a first basic property of said third part and said second part recording a second basic property of said sections.

2. The embedded memory structure of claim 1, wherein said first part is a head of said memory.

3. The embedded memory structure of claim 1, wherein said second part is a head of said section.

4. The embedded memory structure of claim 1, wherein said third part is data section.

5. The embedded memory structure of claim 1, wherein said first basic property records the number and the size of said sections.

6. The embedded memory structure of claim 1, wherein said second basic property records the size, the location in said third part and the compressed degree of said sections.

7. An access method for an embedded memory structure applying to an embedded system, comprising:
pre-dividing the memory into a first part previously, a second part and a third part in advance;
pre-dividing said third part into a plurality of sections in advance, said first part recording a first basic property of said third part, said second part recording a second basic property of said sections;
obtaining a location of said sections in said third part from said second basic property;
obtaining the compress degree of said sections from said second basic property;
accessing said sections; and
de-compressing said sections.

8. The access method of claim 7, wherein said first part is a head of said memory.

9. The access method of claim 7, wherein said second part is a head of said sections.

10. The access method of claim 7, wherein said third part is a data section.

11. The access method of claim 7, wherein said first property records the number and the size of said sections.

12. The access method of claim 7, wherein said second property records the size, the location in said third part and the compressed degree of said sections.

13. A writing method of an embedded memory structure applying to an embedded system, comprising:
pre-dividing said memory into a first part, a second part and a third part in advance;
pre-dividing said third part into a plurality of sections in advance, said first part recording a first basic property of said third part, said second part recording a second basic property of said sections;
compressing a loading section as a compressed section;
re-allocating said sections to provide an space for storing said compressed section;
writing said compressed section into said space; and
updating said second basic property accordingly.

14. The loading method of claim 13, wherein said first part is a head of said memory.

15. The loading method of claim 13, wherein said second part is a head of said sections.

16. The loading method of claim 13, wherein said third part is a data section.

17. The loading method of claim 13, wherein said first property records the number and the size of said sections.

18. The loading method of claim 13, wherein said second property records the size, the location in said third part and the compressed degree of said sections.

19. A partially updated component system for an embedded memory of an embedded system that is applied to a client-server architecture, comprising:
a server device for dividing a data into a plurality of sections, an updated component being stored in at least one of said sections and compressing said updated data of said section, then sending out a compressed section; and
customer device, having a main memory and an embedded memory, wherein said main memory receives said compressed section so as to update the partial sections of said embedded memory through a routine accordingly.

20. The updated component system of claim 19, wherein said embedded memory, further comprising a memory that applies to a storage space of said embedded system and is previously divided into a first part, a second part and a third part; said third part being divided into a plurality of sections, said first part recording the first basic property of said third part and said second part recording the second basic property of said sections.

21. The updated component system of claim 20, wherein said first part is a head of said memory.

22. The updated component system of claim 20, wherein said second part is a head of said sections.

23. The updated component system of claim 20, wherein said third part is a data section.

24. The updated component system of claim 20, wherein said first property records the number and the size of said sections.

25. The updated component system of claim 20, wherein said second property records the size, the location in said third part and the compressed degree of said sections.

26. A partially updated component method for an embedded memory of an embedded system that is applied to a client-server architecture, comprising:
dividing a data into a plurality of sections, at least one of said sections being used to store an updated data section;
compressing said updated data section, then sending out a compressed updated data section from a server device;
receiving said compressed updated data section to be stored in a main memory in a customer device; and
updating the partial sections of said embedded memory through a routine accordingly.

27. The updated component method of claim 26, wherein said embedded memory, further comprising a memory that applies to a storage space of said embedded system and is previously divided into a first part, a second part and a third part; said third part being divided into a plurality of sections, said first part recording the first basic property of said third part and the second part recording the second basic property of said sections.

28. The updated component method of claim 27, wherein said first part is a head of said memory.

29. The updated component method of claim 26, wherein said second part is a head of said section.

30. The updated component method of claim 26, wherein said third part is a data section.

31. The updated component method of claim 26, wherein said first property records the number and the size of said sections.

32. The updated component method of claim 26, wherein said second property records the size, the location in said third part and the compress degree of said sections.
